(19) United States
(12) Patent Application Publication
(10) Pub. No.: US 2011/0040542 A1
(43) Pub. Date: Feb. 17, 2011

(54) METHOD AND SYSTEM FOR THE INTEGRATION OF FUNCTIONAL CAE DATA IN A CAD BASED STYLING PROCESS FOR INDUSTRIAL DESIGN, ESP. CARS, MOTORBIKES OR AERONAUTIC VEHICLES

(75) Inventors: Bernhard SENDHOFF, Bruchkobel (DE); Markus OLHOFER, Babenhausen (DE)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: HONDA RESEARCH INSTITUTE EUROPE GMBH, Offenbach/Main (DE)

(21) Appl. No.: 12/841,293

(22) Filed: Jul. 22, 2010

(30) Foreign Application Priority Data
Aug. 13, 2009 (EP) 09 167 789.8

(51) Int. Cl. G06G 7/48

(52) U.S. Cl. 703/8; 703/6

(57) ABSTRACT

Computer-assisted systems and methods for integrating aesthetic and functional design processes for real-world objects can include a computerized module for defining an aesthetic representation of a real-world object, and a computing module supplied with approximation model data of a CAE simulation module to calculate functional quality value(s) using a parametric description of the aesthetic representation as input. An interface can issue a physical signal to a user, with the physical signal communicating the quality value(s) to the user. A computerized module can change the parametric description of the aesthetic representation of the object in the aesthetic design process taking the obtained functional quality value into account.

### BACKGROUND OF THE INVENTION

In industrial design, e.g. automotive design, the aesthetic styling (aesthetic design) has to be coupled with functional requirements (functional design) and performance measures from CAE (Computer Aided Engineering) systems, e.g. dynamic stability, aerodynamics, computational fluid dynamics (CFD), structural stability, etc. In the overall design process, functional constraints are often used to define the initial conceptual design which is then shaped by the designer according to some aesthetic requirements, e.g. based on the designer's artistic taste and/or on the overall brand design requirements. Traditionally, the aesthetic design phase involves clay models, which are nowadays augmented by CAD models, interactive immersive displays [1] and virtual clay systems [2]. After the aesthetic design phase, again functional requirements can alter the final design and shape.

However, both processes (aesthetic and functional design) are largely decoupled and handled by different groups of people (i.e. designers and engineers).

In general, the representations, i.e. the parametric descriptions of objects, are different for the aesthetic design process and the functional design process.

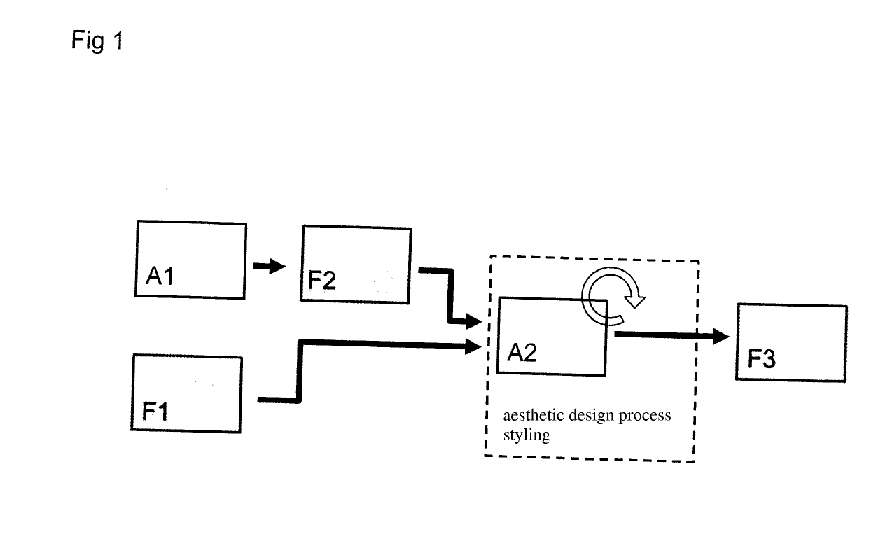

FIG. 1 schematically shows this known approach, wherein steps F1-F3 are optional.

### STATE OF THE ART

The use of surrogate or meta-models has been suggested previously in the context of design optimization without any aesthetic design phase (see e.g. [4,5,6]).

However, as will be explained later in greater detail, in the framework put forward in this patent surrogate models are embedded into the aesthetic design phase in order to enable a tight coupling between aesthetic design and functional design.

Document “Integrated modeling, finite-element analysis, and engineering design for thin-shell structures using subdivision” by F. Cirak et al (Division of Engineering and Applied Science, California Institute of Technology, Pasadena, Calif. 91125, USA, available online 20 Mar. 2002) describes geometric modeling and mechanical simulation of thin flexible structures, such as those found in the automotive and aerospace industries. The use of subdivision surfaces as a foundation for modeling, simulation, and design in a unified framework is described.

Document “Haptic function evaluation of multi-material part design” by Z. Yang et al (Computer-Aided Design, Volume 37, Issue 7 (June 2005), ISSN:0010-4485) describes haptic shape modeling for industrial and conceptual design. A real-time haptic interface of synthesized shape modeling and haptic function evaluation of product design for multi-material part is described.

In contrast to these documents, the invention discloses the combination of aesthetic design with meta-models, which approximate computational aided engineering calculations (CAE). Such calculations can be CFD and/or FEM methods. The integration of the meta-models is not trivial because the aesthetic process and the CAE process work on different representations of the given design. The meta-model adds a third representation.

The invention provides a method which allows aesthetic optimization of an object in a tight coupling with the functional optimization of the object. While these two processes are traditionally separated for the reason that the functional optimization of an object is a very complex and time consuming process, where the aesthetic optimization is a continuous and constant process, the invention teaches to integrate both these processes in a tandem-setup.

The (aesthetic) designer needs to constantly change the aesthetic appearance of the object and it hinders his work if, after every change of the aesthetic appearance of the object, the designer has to wait for the calculations of the functional performance values to be finished (this process, for example, uses computational fluid dynamics CFD). Also, waiting for the results of the calculations leads to a very time consuming design process.

The invention however, solves this problem by using an approximation model of the computer aided engineering (CAE) simulation which allows quickly approximating the CAE calculations and provides an immediate feedback to the designer on the current change. It is also possible to provide to the designer information of alternatives to the design decision which provide better functionality in respect to the functional quality values.

The invention allows a continuous modeling process of the object according to aesthetic measures while allowing direct feedback on its effect on the functional design based on the approximation model.

In brief, the invention works with three models: one for the aesthetic design process, one for the functional changes performed according to the functional quality values and one “meta-model”, the approximation model for the functional model, that allows to quickly approximate the changes performed to the functional model without actually running the full functional calculations

### OBJECT OF THE INVENTION

It is the object of the invention to propose a process that allows a tight coupling between the aesthetic and the functional design processes, thereby achieving an efficient and comprehensive approach for designing real-world objects which at the same time meet physical and aesthetic requirements. E.g. when designing cars, motorbikes and planes using the invention, the physical requirements can be e.g. minimizing weight and/or drag.

Thus the invention also allows the manufacturing of aesthetic real-world objects, which also satisfy functional criteria, which functional criteria can be expressed in terms of physical entities.

This object is achieved by means of the features of the independent claims. The dependent claims develop further the central idea of the present invention.

A first aspect of the invention relates to a method for providing designers direct feedback on the functional quality of their current aesthetic design of real-world objects, thus improving the design process and facilitating the manufacturing of aesthetic and functional real-world object.

The method comprising the following steps:
a) a representation (i.e. a parametric description) of an object from the aesthetic design process (e.g. CAD data) is given,
b) from the given representation a quality value is derived (computed by a artificial computing unit) based on physical requirements of the functional design process,
c) a (e.g. haptic, visual or acoustical) physical signal is issued to a user, the physical signal communicating the quality value to the user,
d) the object is changed resulting in different parameters of the representation according to the aesthetic requirements of the designer taking the functional quality value into account,
e) steps b) to d) are repeated until a termination criterion is met.

The invention also proposes a method comprising the following steps additional or alternative:
a representation (i.e. a parametric description) of an object from the aesthetic design process (e.g. CAD data) is given,
from the given representation a quality value is derived based on the physical requirements of the functional design process,
a computational optimization process is invoked where the object is slightly altered as to minimize/maximize the quality value which is derived based on the physical requirements of the functional design process,
a physical signal is issued to a user, the physical signal communicating to a user as how to modify the design in order to achieve an improved quality value, or the physical signal communicating to the user at least one alternative design having an improved quality value,
the object is changed resulting in different parameters of the representation according to the aesthetic requirements of the designer taking the functional quality value into account,
steps b) to d) are repeated until a termination criterion is met.

The method may comprise the additional or alternative step of:
building the real world object based on the representation (i.e. parametric description) of the object present when the termination criterion has been met.

The method may comprise the following steps:
a) defining an aesthetic representation of a physical object,
b) performing a transformation of the aesthetic representation of the object to a functional representation,
c) using an approximation model of a CAE simulation to calculate functional quality value(s) using a parametric description of the functional representation as input,
d) issuing a physical signal to a user, the physical signal communicating the quality value(s) to the user,
e) automated changing, upon input from a user interface, the parametric description of the aesthetic representation of the object in the aesthetic design process taking the obtained functional quality value into account, and
f) repeating steps b) to d) until a termination criterion is met.

The method may comprise additionally or alternatively at least one of the following steps:
using an approximation model of a CAE simulation to calculate functional quality value(s) using the parametric description of the aesthetic representation as input,
changing the parametric description of the aesthetic representation and deriving the quality values using the approximation model for these design variations in order to perform a sensitivity analysis of the quality values for a set of design variations,
issuing a physical signal to a user, the physical signal communicating the sensitivity of the quality values for different changes of the parametric description of the aesthetic representation of the design to the user,
automated changing, upon input from a user interface, the parametric description of the aesthetic representation of the object in the aesthetic design process taking the obtained sensitivity analysis into account.

The method may comprise additionally or alternatively at least one of the following steps:
running an optimization process in order to produce at least one modified design with improved quality values using the approximation model of a CAE simulation as a cost function during the optimization process,
issuing a physical signal to a user, the physical signal communicating to a user as how to modify the design in order to achieve an improved quality value,
automated changing, upon input from a user interface, the parametric description of the aesthetic representation of the object in the aesthetic design process taking the result of the optimization process into account.

The aesthetic representation of the design may be based on CAD data, while the optimization process will be performed based on a different functional representation, e.g. free form deformation [8] or NURBS [7].

The derivation of the functional quality of the aesthetic design which is required in the first process as well as in the second process including the additional optimization loop has to be very fast so that the designer receives direct and real-time feedback of the functional quality of the object (besides his own aesthetic judgment). Current CAE methods do not allow this fast feedback, therefore, models have to be employed, which represent a functional approximation of the CAE calculations. Examples of such models (which have been termed surrogates or meta-models or surrogate models in the context of functional design optimization [4]) are neural networks, Kriging (Gaussian) models, response surface models, polynomial models. Based on available CAE data that has been generated prior to the aesthetic design process (and which can also constantly be updated during the aesthetic design process), the model is generated using methods from e.g. neural network learning or mathematical statistics. Such models can then replace the costly CAE calculations. The models are very fast and can be used in real-time in direct interaction with the designer. The models can directly receive the aesthetic object representation, e.g. CAD data, as input or use their own model-dependent representation. In the latter case, a transformation has to be included from the aesthetic representation to the model representation.

Step d) may be done in order to change the aesthetic appearance of the design.

The physical signal may be a visual indication and/or a haptic feedback.

The invention also relates to computer software program product, implementing a method according to any of the preceding claims when run on a computing device.

The invention furthermore relates to a computer-assisted system for designing real-world objects, the system comprising the following steps:
a) a module for providing a representation (i.e. a parametric description) of an object from the aesthetic design process (e.g. CAD data),
b) a module for deriving a quality value from the given representation based on the physical requirements of the functional design process,
c) an interface for issuing a physical signal to a user, the physical signal communicating the quality value to the user,
d) a modification interface for changing the object resulting in different parameters of the representation according to the aesthetic requirements of the designer taking the functional quality value into account

Finally the invention relates to a computer-assisted system for designing real-world objects, the system comprising:
a) a module for providing a representation (i.e. a parametric description) of an object from the aesthetic design process (e.g. CAD data),
b) a module for deriving a quality value from the given representation based on the physical requirements of the functional design process,
c) a module for executing a computational optimization process where the object is slightly altered as to minimize/maximize the quality value which is derived based on the physical requirements of the functional design process,
c) an interface for issuing a physical signal to a user, the physical signal communicating to a user as how to modify the design in order to achieve an improved quality value, or the physical signal communicating to the user at least one alternative design having an improved quality value, and
d) a modification user interface for changing the object resulting in different parameters of the representation according to the aesthetic requirements of the designer taking the functional quality value into account.

In an further aspect the invention relates to a computer-assisted system for integrating aesthetic and functional design processes for physical objects, the system may comprise:
a) a computerized module for defining an aesthetic representation of a physical object,
b) a computerized module for defining a transformation of the aesthetic representation of the object to a functional representation,
c) a computing module supplied with approximation model data of a CAE simulation module to calculate functional quality value(s) using a parametric description of the functional representation as input,
d) an interface for issuing a physical signal to a user, the physical signal communicating the quality value(s) to the user, and
e) a computerized module for changing, upon input from a user interface, the parametric description of the aesthetic representation of the object in the aesthetic design process taking the obtained functional quality value into account.

The system may comprise additionally or alternatively at least one of:
a module for changing the parametric description of the aesthetic representation and for deriving the quality values using the approximation model for these design variations in order to perform a sensitivity analysis of the quality values for a set of design variations,
an interface for issuing a physical signal to a user, the physical signal communicating the sensitivity of the quality values for different changes of the parametric description of the aesthetic representation of the design to the user, and
a computerized module for changing, upon input from a user interface, the parametric description of the aesthetic representation of the object in the aesthetic design process taking the obtained sensitivity analysis into account. The system may comprise additionally or alternatively at least one of:
an optimization module producing at least one modified design with improved quality values using the approximation model of the CAE simulation module as a cost function during the optimization process,
an interface for issuing a physical signal to a user, the physical signal communicating to a user as how to modify the design in order to achieve an improved quality value, and
a computerized module for changing, upon input from a user interface, the parametric description of the aesthetic representation of the object in the aesthetic design process taking the result of the optimization process into account.

A preferred embodiment of the present invention is now described with reference to the figures where like reference numbers indicate identical or functionally similar elements. Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

Further features, objects and advantages of the invention will become evident when reading the following detailed description of an embodiment, taken in conjunction with the figures of the enclosed drawings.

FIG. 1 is a general view of the modules of a known design system.

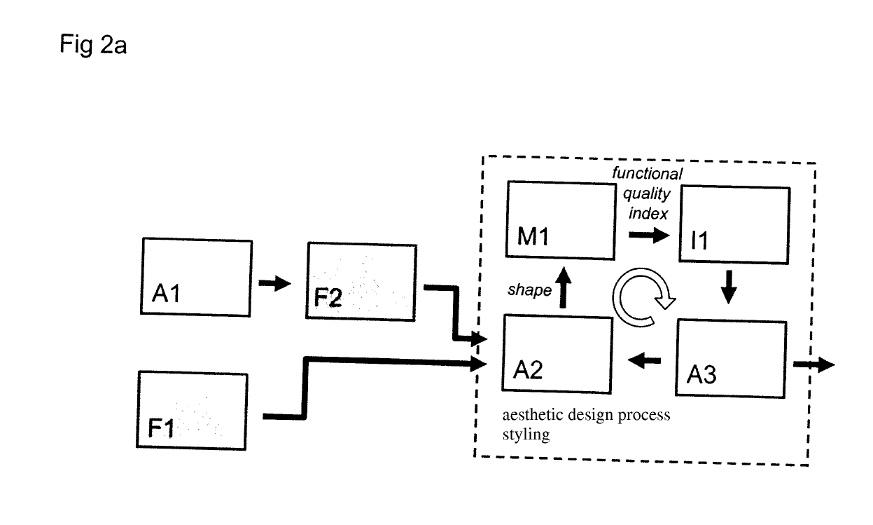

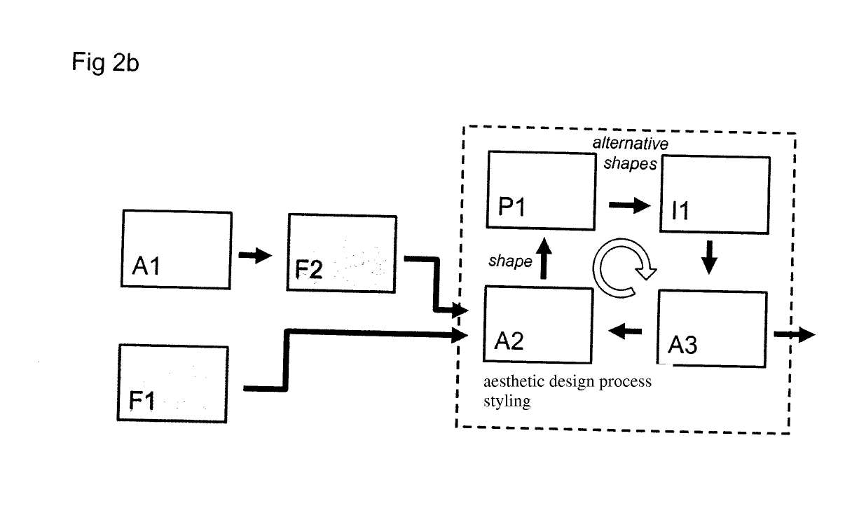

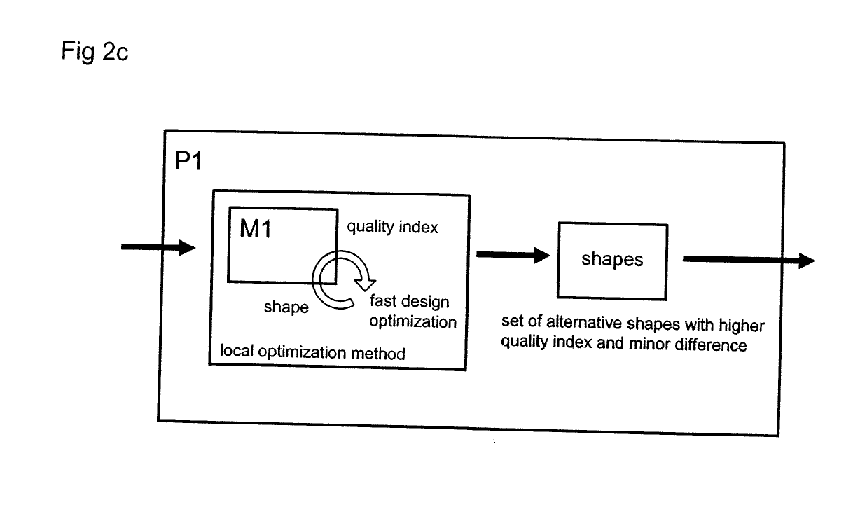

FIG. 2a is a general view of the modules of a first embodiment of a design system according to the invention where only a functional quality value is communicated to the user.

FIG. 2b is a modification of the system of FIG. 2a where an additional optimization loop is executed and alternative designs or design directions are communicated to the user.

FIG. 2c shows details of the optimization module P1 of FIG. 2b.

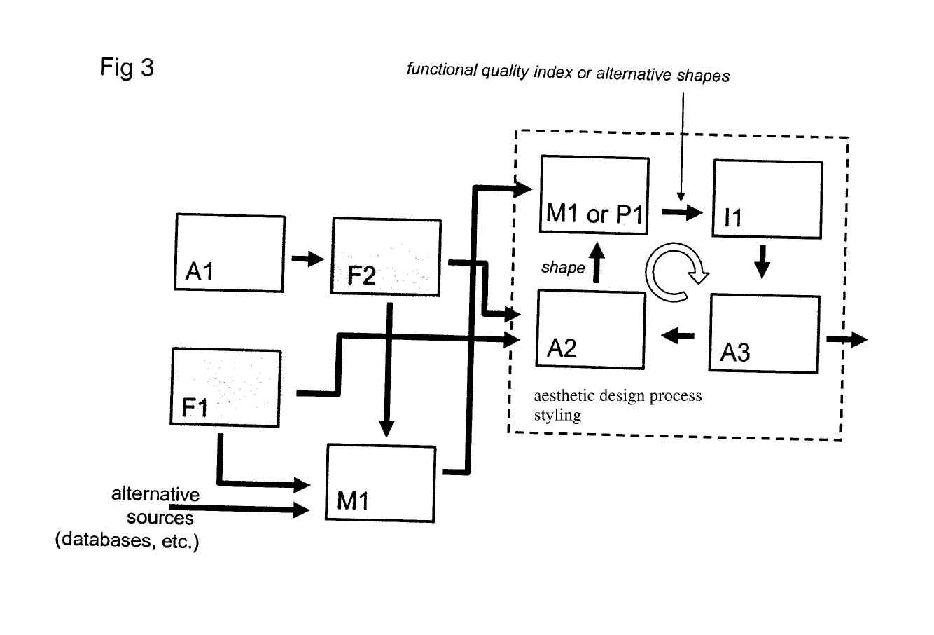

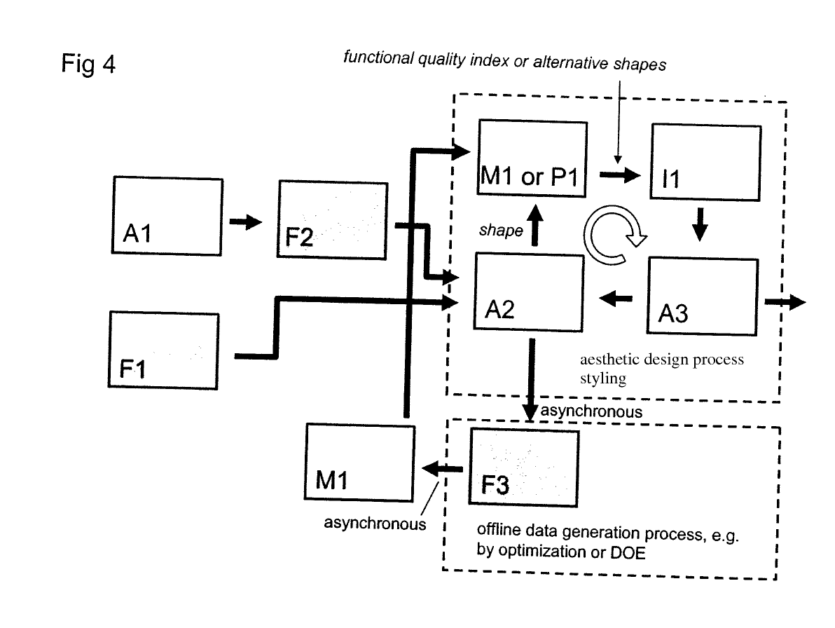

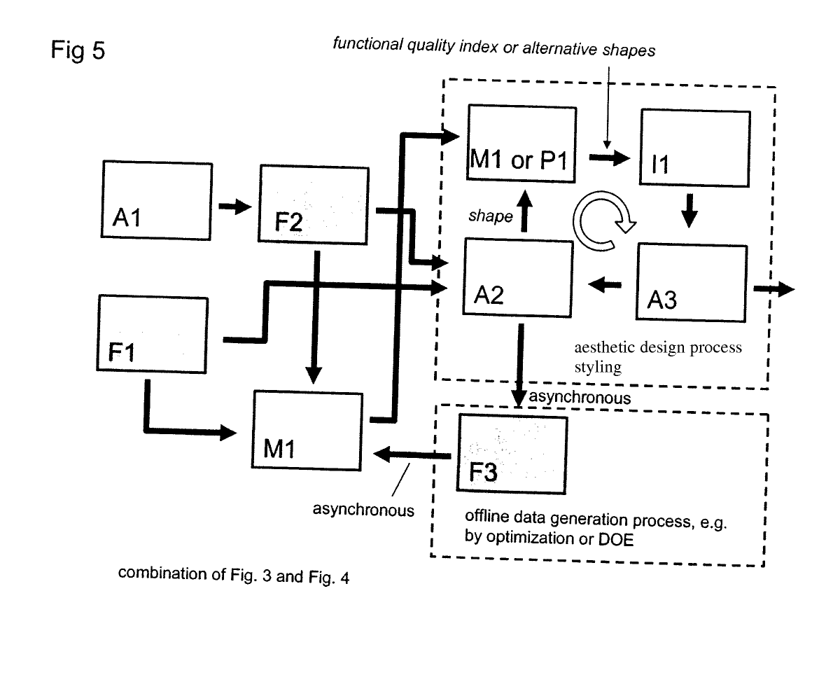

FIG. 3 shows the training of the model (targeting the correct functional approximation) with a-priori available functional data. This is used in conjunction with the processes depicted in FIGS. 2a and 2b.

FIG. 4 shows the additional training of the model (targeting the correct functional approximation) with data generated during the design process. This is used in conjunction with the processes depicted in FIGS. 2a and 2b.

FIG. 5 shows the combination of a-priori and online training of the model (FIG. 3 and FIG. 4).

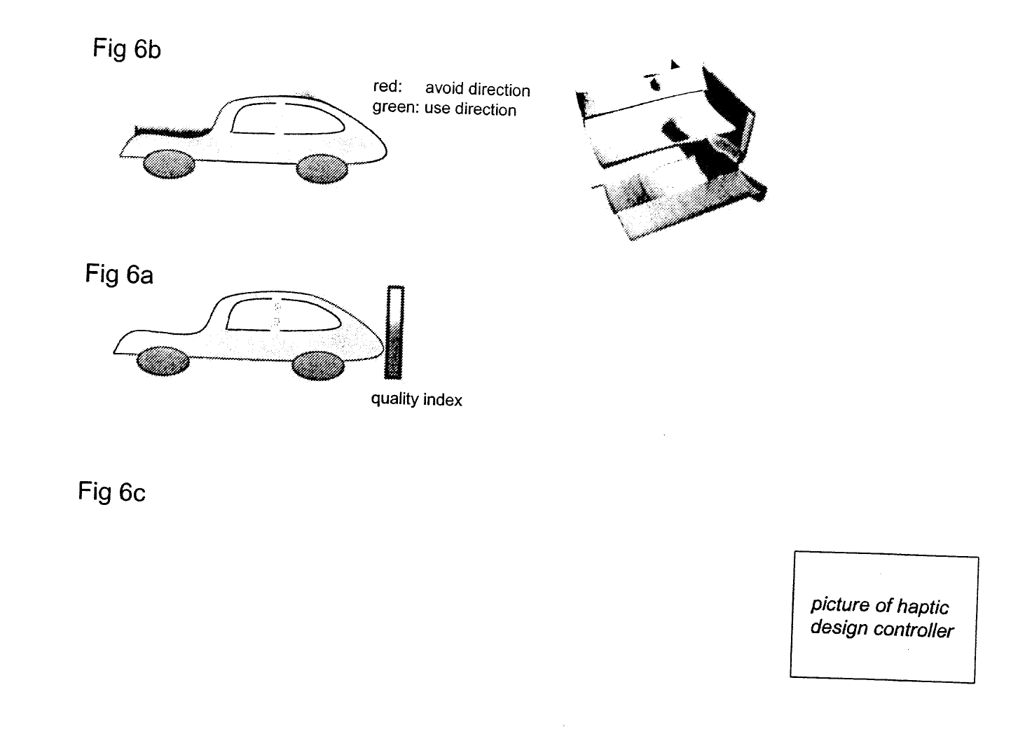

FIGS. 6a to 6c show examples of interfacing results of the functional quality estimation and/or functional optimization back to the user. 6a: displaying a quality index of an aesthetic design, 6b: colour encoding of favourable and unfavourable (according to the functional quality values) directions for the aesthetic design process, 6c: haptic encoding of favourable and unfavourable (according to the functional quality values) directions for the aesthetic design process.

To summarize, the invention proposes to at least partially merge the computer based (CAD, immersive interactive displays, virtual clay systems) aesthetic design phase with the functional design process e.g. from CAE systems. This makes the overall process more efficient, the aesthetic process more comprehensive, i.e. no changes are made to the styling after the aesthetic design process has been completed, and the integration of functional requirements easier and as a result more comprehensive. In order to allow such a tight integration of both processes and therefore to realize the described advantages, mainly two problems have to be solved. Firstly, the computation time required for the CAE analysis (e.g. aerodynamic parameters with computational fluid dynamics CFD, or dynamic stability) does not allow the online calculation of CAE based functional performance indices during the aesthetic based design process, i.e. while the stylist is constantly changing the shape of a design (e.g. an automotive), it is not possible to continuously calculate the quality indices for every shape. Secondly, if the performance indices for each shape are available (i.e. question one is solved), how can this information be conveyed to the stylist in a way that s/he (who does not necessarily have a strong technological background) can use this information most efficiently.

### DETAIL OF THE INVENTION

The problems formulated in the above section are solved in the following ways. In order to circumvent the time constraint, a model M1 will be used during the aesthetic design process instead of the true CAE calculations. This model serves a similar purpose as surrogate models during traditional design optimization. A variety of different model structures are conceivable, examples are neural networks, response surface models, polynomial models, Kriging (Gaussian) models. These models approximate the function of the CAE calculations. Since the model response time is very fast it can be used during the design process as an immediate feedback to the designer on the current shape as shown in FIG. 2a.

Additionally, a fast optimization process can be carried out using the model as a quality measure (denoted by process P1 in FIG. 2b), which would not only provide a quality feedback on the current shape to the designer, but also alternative similar shapes with a better functional quality (i.e. with respect to CAE calculations like CFD) and information on the sensitivity of the current shape with respect to future changes (e.g. encoded by the interface specified in FIG. 6b).

In general, different representations of the object (i.e. its parametric description) will be used for the aesthetic design process, for the functional design process and for the model. When merging the different processes, interfaces between those representations are necessary. Representations suitable for the aesthetic design processes are usually determined by the computational tools used by the designers, a standard tool and the associate representations are CAD data. The functional representations have to be low dimensional and have to be suitable for computational changes of the design in the context of CAE systems like fluid dynamics. Since most CAE systems rely on a computational grid or mesh for the calculations, functional representations must either be able to adapt the computational grid of the CAE solver or they must be suitable for automatically generating new grids/meshes during the functional design process based on the current functional representation. NURBS [7] and free form deformation [8] representations have been shown to be very suitable functional representations. Model representations are usually low dimensional functional representations. Universal representations like STL representations [9] can be employed in order to switch between the three types of representations.

Therefore, in a typical embodiment of the invention, the model receives a parameterization of the shape as input, e.g. the control points of a NURBS representation or a Free Form Deformation representation, see e.g. [7, 8] or alternatively CAD representations. The output of the model would be a quality index/value or several quality indices/values that are used to functionally characterize the design (e.g. drag coefficients for aerodynamic optimization of automotive chassis).

The second problem on how to convey the information back to the designer can be solved in different ways. In the case of FIG. 2a, i.e. when a quality value for the current design is calculated this can be displayed e.g. visually to the designer, e.g. using a color code (red: bad, green: good performance or a performance column (meter) as shown in FIG. 6a, where the height corresponds to the quality. In the case of FIG. 2b, where alternative shapes are available, more sophisticated interfaces are proposed.

Firstly, promising directions can be calculated from the current shape and the shapes produced by the optimization process P1, these directions can be color coded and displayed behind (left figure) or on (right figure) the current design (FIG. 6b), e.g. changes normal to the shape where the design is red are to be avoided and where the design is green (or blue) changes normal to the current shape are likely to increase the functional performance. Furthermore, the shape information can be communicated back to the designer in more subtle ways as described in FIG. 6c. Haptic force feedback on the controller which is used by the designer in a virtual or augmented reality environment for the digital design process is used as an interface. This force can slightly (adjustable) push the variations which the designer induces with the controller in a certain direction that is desirable from a functional perspective and that has been derived from the original shape and the shapes calculated in the optimization process P1. Furthermore, design variations in functionally undesirable directions can be made more difficult by increasing the resistance of the controller in that direction.

FIGS. 3 and 4 describe additional ways how the model M1 (or models if an ensemble of models is being used) can be improved using data available before the aesthetic design process starts (FIG. 3) or data that is generated during the aesthetic design process (FIG. 4). In the later case, it is important that both processes are run asynchronously. In general, the aesthetic design process will change the shapes (denoted by A2 and A3 in the figures) much faster than the CFD calculation (one needs several hours), so the “aesthetic design loop” has to proceed while the CFD calculation runs. At the same time, during the night or during weekend or due to other constraints, the aesthetic design process will stop and several CFD calculations might be possible using design of experiments methods or optimization methods. This information will then be fed back to the model M1.

### Application Areas

The invention may find application in the design of any real-world object, but especially in the following fields: Land, Air and Sea vehicles, Automotive design, motorcycle design, aeronautic design, boat design, furniture design, industrial design.

### Glossary

CAD—computer aided design

CAE—computer aided engineering

CFD—computational fluid dynamics

Aesthetic design—a process involving a designer where an object is shaped according to the artistic taste of the designer and/or according to some brand specifics (e.g. automotive design, furniture design)

Functional design—a process where an object is shaped according to some objective physical quality measures provided by experiments (including computer experiments), e.g. minimization of drag, maximization of thermal resistance, maximization of crash resistance.

Aesthetic representation—a parametric description of an object that is most suitable for variations invoked by a human designer during the aesthetic design process, e.g. CAD data or digital clay data

Functional representation—a parametric description of an object that is most suitable for determining the physical quality measures of the object and/or for variations invoked by a computer program during an optimization process, e.g. free form deformation [8] or NURBS [7].

Model representation—a parametric description of an object that is most suitable for determining the physical quality measures of the object based on a specific model (e.g. a neural network). Often such a representation is a lower dimensional version of a functional representation.

### PRIOR ART REFERENCES

[1] P. O'B Holt, J. M Ritchie, P. N. Day, J. E. L. Simmons, G. Robinson, G. T. Russell, and F. M. Ng. Immersive Virtual Reality In Cable and Pipe Routing: Design Metaphors and Cognitive Ergonomics. ASME Journal of Computing and Information Science in Engineering, 4 (3), 161-170, 2004.

[2] SensAble Technologies. 3D Touch-enabled Modeling for Product Design, Digital Content Creation (DCC) & Fine Arts. http://www.sensable.com/industries-design-model.htm

[3] Douglas C. Montgomery. Design and Analysis of Experiments. Wiley & Sons, 7th edition, 2009.

[4] Yaochu Jin, Markus Olhofer and Bernhard Sendhoff. A

Framework for Evolutionary Optimisation with Approximate Fitness Functions. IEEE Transactions on Evolutionary Computation, 6 (5), pages 481-494, 2002.

[5] EP 1205877 A1 “Approximate fitness functions” of Honda Research Institute Europe GmbH

[6] EP 1557788 A1 “Reduction of fitness evaluations using clustering technique and neural network ensembles” of Honda Research Institute Europe GmbH

[7] Les Piegl and Wayne Tiller. The NURBS book. Springer, 1996.

[8] Stefan Menzel and Bernhard Sendhoff. Representing the change—free form deformation for evolutionary design optimization. In T. Yu, L. Davis, C. Baydar and R. Roy (Eds) Evolutionary Computation in Practice, 63-86, 2008.

[9] Lars Graening, Stefan Menzel, Martina Hasenjäger, Thomas Bihrer, Markus Olhofer and Bernhard Sendhoff. Knowledge Extraction from Aerodynamic Design Data and its Application to 3D Turbine Blade Geometries. In Journal of Mathematical Modelling and Algorithms, 7 (4), 329-350, 2008.

Yang, Z., Lian, L., and Chen, Y. 2005. Haptic function evaluation of multi-material part design. Comput. Aided Des. 37, 7 (June 2005), 727-736.

Fehmi Cirak, Michael J. Scott, Erik K. Antonsson, Michael Ortiz, Peter Schroder, Integrated modeling, finite-element analysis, and engineering design for thin-shell structures using subdivision, Computer-Aided Design, Volume 34, Issue 2, February 2002, Pages 137-148, ISSN 0010-4485, DOI: 10.1016/S0010-4485(01)00061-6.

1. A method for integrating aesthetic and functional computerized design processes for real-world objects, the method comprising the following steps:
a) defining an aesthetic representation of a real-world object,
b) using an approximation model of a CAE simulation to calculate functional quality value(s) using the parametric description of the aesthetic representation as input,
c) issuing a physical signal to a user, the physical signal communicating the quality value(s) to the user,
d) automated changing, upon input from a user interface, the parametric description of the aesthetic representation of the object in the aesthetic design process taking the obtained functional quality value into account, and
e) repeating steps b) to d) until a termination criterion is met.

2. A method for integrating aesthetic and functional computerized design processes for real-world objects, the method comprising the following steps:
a.) defining an aesthetic representation of a real-world object,
b.) using an approximation model of a CAE simulation to calculate functional quality value(s) using the parametric description of the aesthetic representation as input,
c.) changing the parametric description of the aesthetic representation and deriving the quality values using the approximation model for these design variations in order to perform a sensitivity analysis of the quality values for a set of design variations,
c.) issuing a physical signal to a user, the physical signal communicating the sensitivity of the quality values for different changes of the parametric description of the aesthetic representation of the design to the user,
d.) automated changing, upon input from a user interface, the parametric description of the aesthetic representation of the object in the aesthetic design process taking the obtained sensitivity analysis into account,
e.) repeating steps b.) to d.) until a termination criterion is met.

3. The method according to the claim 1, wherein a transformation is performed from the aesthetic representation to the model representation and where the approximation model receives the parametric description of the model representation of the object as input.

4. A method for integrating aesthetic and functional computerized design processes for real-world objects, the method comprising the following steps:
a.) defining an aesthetic representation of a real-world object,
b.) defining a transformation of the aesthetic representation of the object to a functional representation,
b.) using an approximation model of a CAE simulation to calculate functional quality value(s) using the parametric description of the functional representation as input,
c.) running an optimization process in order to produce at least one modified design with improved quality values using the approximation model of a CAE simulation as a cost function during the optimization process,
d.) issuing a physical signal to a user, the physical signal communicating to a user as how to modify the design in order to achieve an improved quality value,
e.) automated changing, upon input from a user interface, the parametric description of the aesthetic representation of the object in the aesthetic design process taking the result of the optimization process into account, and
f.) repeating steps c.) to d.) until a termination criterion is met.

5. The method according to claim 1, wherein a transformation is performed from the functional representation to the model representation and where the approximation model receives the parametric description of the model representation of the object as input.

6. The method according to claim 2, wherein a transformation is performed from the functional representation to the aesthetic representation in order to derive the most suitable physical signal to be communicated back to the user.

7. The method according to claim 1, comprising the additional step of building the real world object based on the aesthetic or functional representation present when the termination criterion has been met.

8. The method according to claim 1, wherein the initial aesthetic representation of the design is based on CAD data.

9. The method according to claim 1, wherein the functional representation of the design is based on a free form deformation.

10. The method according to claim 1, wherein the functional representation of the design is based on a NURBS representation.

11. The method according to claim 1, wherein the physical signal is a visual indication and/or a haptic feedback.

12. The method according to claim 1, wherein the approximation model is derived using a priori available data relating the parametric description of the model representation and/or the functional representation and/or the aesthetic representation to the functional quality value(s) of the design.

13. The method according to claim 1, wherein the approximation model is updated or newly derived during the integrated design process by using data generated asynchronously from CAE simulations

14. The method according to claim 1, wherein the approximation model is a neural network.

15. The method according to claim 1, wherein the approximation model is a Kriging (Gaussian) model.

16. The method according to claim 1, wherein the optimization is carried out with an evolution strategy.

17. The method according to claim 1, performing and/or designing a transformation of the aesthetic representation of the object to a functional representation.

18. The method according to claim 1, wherein the real-world object is a physical object.

19. Use of a method according to claim 1 for designing automobiles, motorbikes or aeronautic vehicles.

20. A computer-assisted system for integrating aesthetic and functional design processes for real-world objects, the system comprising:
a) a computerized module for defining an aesthetic representation of a real-world object,
b) a computing module supplied with approximation model data of a CAE simulation module to calculate functional quality value(s) using a parametric description of the aesthetic representation as input,
c) an interface for issuing a physical signal to a user, the physical signal communicating the quality value(s) to the user, and
d) a computerized module for changing, upon input from a user interface, the parametric description of the aesthetic representation of the object in the aesthetic design process taking the obtained functional quality value into account.

21. A computer-assisted system for integrating aesthetic and functional design processes for real-world objects, the system comprising:
a.) a computerized module for enabling a user to define an aesthetic representation of a real-world object,
b.) a computing module supplied with approximation model data of a CAE simulation module to calculate functional quality value(s) using a parametric description of the functional representation as input,
c.) a module for changing the parametric description of the aesthetic representation and for deriving the quality values using the approximation model for these design variations in order to perform a sensitivity analysis of the quality values for a set of design variations,
c.) an interface for issuing a physical signal to a user, the physical signal communicating the sensitivity of the quality values for different changes of the parametric description of the aesthetic representation of the design to the user, and
d.) a computerized module for changing, upon input from a user interface, the parametric description of the aesthetic representation of the object in the aesthetic design process taking the obtained sensitivity analysis into account. A computer-assisted system for integrating aesthetic and functional design processes for real-world objects, the system comprising:
a.) a computerized module for enabling a user to define an aesthetic representation of a real-world object,
b.) a computerized module for defining a transformation of the aesthetic representation of the object to a functional representation,
b.) a computing module supplied with approximation model data of a CAE simulation module to calculate functional quality value(s) using a parametric description of the functional representation as input,
c.) an optimization module producing at least one modified design with improved quality values using the approximation model of the CAE simulation module as a cost function during the optimization process,
d.) an interface for issuing a physical signal to a user, the physical signal communicating to a user as how to modify the design in order to achieve an improved quality value, and
e.) a computerized module for changing, upon input from a user interface, the parametric description of the aesthetic representation of the object in the aesthetic design process taking the result of the optimization process into account.

22. The computer-assisted system of claim 20, comprising a computerized module for defining a transformation of the aesthetic representation of the object to a functional representation.
